(19) United States
(12) Patent Application Publication
(10) Pub. No.: US 2023/0070827 A1
(43) Pub. Date: Mar. 9, 2023

(54) ACCELERATING COMPUTATIONS IN A PROCESSOR

(71) Applicant: Telefonaktiebolaget LM Ericsson (publ), Stockholm (SE)

(72) Inventors: Martin HESSLER, Linköping (SE); Niclas WIBERG, Linköping (SE)

(21) Appl. No.: 17/800,040

(22) PCT Filed: Feb. 18, 2021
(86) PCT No.: PCT/EP2021/053934

§ 371 Date: Aug. 16, 2022

Related U.S. Application Data
(60) Provisional application No. 62/993,245, filed on Mar. 23, 2020.

(51) Int. Cl. G06F 9/48; G06F 17/14

(52) U.S. Cl. CPC G06F 9/4881; G06F 17/142

(57) ABSTRACT

Accelerating computations in a processor having one or more processing units, wherein one or more threads of execution are associated with one or more processing elements and with a shared memory of the one or more processing units for performing computations by parallel execution of the threads. Computations are performed by parallel execution of the one or more threads in the one or more processing elements by using the shared memory. The or more threads are synchronized by: determining dependent computations of the one or more threads in a warp, wherein the warp includes a pre-determined number of threads, mapping adjacent entries of a fast Fourier transform to respective threads of the determined dependent computations of the warp, exchanging data between the one or more respective threads, and performing the determined dependent computations of the respective threads based on exchanged data between the one or more respective threads.

### TECHNICAL FIELD

The present disclosure relates generally to the field of computations in a processor. More particularly, it relates to accelerating computations in a processor comprising one or more processing units.

### BACKGROUND

Fast Fourier transforms (FFT) are used extensively in many technical fields. FFT computations are suitable for multithreading.

For accelerating computations (such as FFT computations), i.e., performance, in a processor, performance evolution is done by increasing the number of processing units and number of threads in the processor.

A drawback of increasing the number of processing units and number of threads in the processor is that the amount of processing increases as the increased number of processing units and number of threads need to be managed in order to perform the computations correctly.

Therefore, there is a need for alternative approaches for accelerating computations in a processor.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an apparatus is referred to herein, it is to be understood as a physical product. The physical product may comprise one or more parts, such as controlling circuitry in the form of one or more controllers, one or more processors, or the like.

It is an object of some embodiments to solve or mitigate, alleviate, or eliminate at least some of the above or other drawbacks.

According to a first aspect, this is achieved by a method for accelerating computations in a processor comprising one or more processing units, wherein one or more threads of execution are associated with one or more processing elements and with a shared memory of the one or more processing units for performing computations by parallel execution of the one or more threads.

The method comprises performing computations by parallel execution of the one or more threads in the one or more processing elements by using the shared memory.

The method further comprises synchronizing the one or more threads by: determining dependent computations of the one or more threads in a warp, wherein the warp comprises a pre-determined number of threads, mapping adjacent entries of a fast Fourier transform (FFT) to respective threads of the determined dependent computations of the warp, exchanging data between the one or more respective threads, and performing the determined dependent computations of the respective threads based on exchanged data between the one or more respective threads.

In some embodiments the method further comprises increasing recursively a set of adjacent FFT thread indices for each step in the FFT and calculating corresponding data entry indices as intermediate results.

In some embodiments, the exchanged data between the one or more respective threads comprises the intermediate results.

In some embodiments, the exchanging of data between the one or more respective threads comprises exchanging data directly between the one or more respective threads and/or by using the shared memory.

In some embodiments, the mapping of the entries in the FFT comprises reordering symbols of FFT entry indices and arranging an order of the FFT thread entries in accordance with the mapping.

In some embodiments, the one or more processing units are associated to a global memory.

In some embodiments, the method further comprises reading data from the global memory, and writing data back to the global memory.

In some embodiments, the reordering comprises shuffling symbols of the FFT entry indices to bit-reverse the order of the FFT thread entries for a Radix-2 FFT.

In some embodiments, the global memory comprises Dynamic Random Access Memory (DRAM).

In some embodiments, the shared memory comprises Static Random Access Memory (SRAM).

In some embodiments, the processor comprises a Graphics Processing Unit (GPU).

In some embodiments, the one or more processing units comprise arithmetic functional units.

In some embodiments, the one or more processing units are configured to create, manage, schedule, and execute one or more threads.

In some embodiments, the one or more processing units comprise one or more cores.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for accelerating computations in a processor comprising one or more processing units, wherein one or more threads of execution are associated with one or more processing elements and with a shared memory of the one or more processing units for performing computations by parallel execution of the one or more threads.

The apparatus comprises a controller being configured to cause computations by parallel execution of the one or more threads in the one or more processing elements by using the shared memory.

The controller being further configured to cause the one or more threads being synchronized by: determination of dependent computations of the one or more threads in a warp, wherein the warp comprises a pre-determined number of threads, mapping of adjacent entries of a fast Fourier transform (FFT) to respective threads of the determined dependent computations of the warp, exchange of data between the one or more respective threads, and performance of the determined dependent computations of the respective threads based on exchanged data between the one or more respective threads.

In some embodiments, the apparatus is operably connectable to general-purpose hardware comprising processing elements configured to perform computations by parallel execution of the one or more threads.

In some embodiments, the general-purpose hardware comprising the processing elements is comprised in the processor and/or in a cloud environment.

A fourth aspect is a processor comprising the apparatus according to the third aspect.

In some embodiments, the processor comprises a Graphics Processing Unit (GPU).

Any of the above aspects may additionally have features identical with or corresponding to any of the various features as explained above for any of the other aspects.

An advantage of some embodiments is that alternative approaches for accelerating computations in a receiver are provided.

Yet an advantage of some embodiments is that computations by parallel execution of the one or more threads in the one or more processing elements is enabled by thread synchronization.

Yet an advantage of some embodiments is that faster calculation speed, less computational overhead and less memory utilization, i.e., memory access are achieved compared to what is possible according to prior art approaches.

Yet an advantage of some embodiments is that parallel execution of the one or more threads enable more efficient implementation in terms of utilizing available resources in hardware compared to what is possible according to prior art approaches.

It should be noted that, even if embodiments are described herein in the context of verifying data integrity in a receiver, some embodiments may be equally applicable and/or beneficial also in other contexts.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a schematic block diagram illustrating example hardware according to some embodiments;

FIG. 3 is a schematic drawing illustrating example data access pattern according to some embodiments;

FIG. 4 is a schematic block diagram illustrating an example apparatus according to some embodiments; and

FIG. 5 is a schematic drawing illustrating an example computer readable medium according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As mentioned above, a drawback of increasing the number of processing units and number of threads in the processor is that the amount of processing increases as the increased number of processing units and number of threads need to be managed in order to perform the computations correctly.

For example, multiple threads are mapped to the same processing unit and the processing units in turn are mapped to caches, e.g. L1 for one processing unit, L2 for multiple processing units etc. The exact structure may vary between different implementations.

For example, a processor may comprise 80 processing units, each such processing unit may comprise 64 cores and 256 kB register memory that is divided between threads, and 128 kB shared/L1 memory that can be shared between threads and used for both data and program.

Each thread may be associated with a set of registers, which is basically memory for storing values needed for the computations and each processing unit may have 256 kB for this purpose.

Each processing unit may handle one or more so called thread blocks each containing up to 1024 threads. The threads are divided into groups of 32 threads, each such group is denoted warp.

In performance oriented programing, at least two aspects are considered; firstly, thread synchronization, and secondly, memory access.

In a processor architecture there are a number of options for thread synchronization (e.g. _syncwarp and _syncthreads). The first command (_syncwarp) will synchronize all threads in each warp (up to 32 threads) and the second command (_syncthreads) will synchronize all threads in a thread block (up to 1024 threads). There are also methods for synchronization between thread blocks.

For memory access there is similarly a method for exchanging memory between threads in the same warp (e.g. _shfl_down_sync) and between threads in the same thread block (e.g. via shared memory). Between thread blocks you need to go to the processor (e.g. Graphics Processing Unit (GPU)) Random Access Memory (RAM).

A drawback of synchronizing many threads is that it typically incurs further processing time and even more so if needed to go up in memory hierarchy.

In the following, embodiments will be presented where alternative approaches for accelerating computations in a processor are described.

Threads, as described herein, typically comprises threads of execution, wherein a thread is a sequence of programmed instructions that may be managed independently by a scheduler, which is typically a part of an operating system.

For example, a thread may comprise a set of computations.

Thread synchronization, as described herein, typically comprises ensuring that two or more concurrent threads do not simultaneously execute a particular program segment known as a critical section.

Parallel execution, as described herein, typically comprises execution of two or more threads which are carried out simultaneously in hardware comprising one or more processing elements.

General-purpose hardware, as described herein, typically comprises hardware comprising one or more processing elements associated with shared memory of one or more processing units, wherein the one or more processing elements are configured to process parallelized execution of threads.

Data accesses, as described herein, typically comprises memory accesses for loading and/or storing data from or to memory.

Data access patterns, as described herein, typically comprises memory access patterns with which a system or program reads and writes memory.

A warp, as described herein, typically comprises a set of 32 threads within a thread block, wherein the threads in a warp may be selected serially by a processing unit.

A thread block, as described herein, typically comprises a set of 1024 threads that are grouped together for process and data mapping purposes.

It should be noted that, even if embodiments are described herein in the context of accelerating computations in a processor, wherein one or more threads of execution are associated with one or more processing elements and with a shared memory of one or more processing units for performing computations by parallel execution of the one or more threads, some embodiments may be equally applicable and/or beneficial also in other contexts wherein computations are accelerated by parallel execution of one or more threads.

It should further be noted that, even if embodiments are described herein in the context of general-purpose hardware with one or more parallel processing elements configured to accelerate computations by parallel execution of one or more threads, some embodiments may be equally applicable and/or beneficial also in other contexts wherein each of the one or more processing elements are configured to accelerate computations by parallel execution of a set of threads in series.

It should furthermore be noted that, even if embodiments are described herein in the context of exchanging data between the one or more respective threads, some embodiments may be equally applicable and/or beneficial also in other contexts wherein data is exchanged between sets of threads.

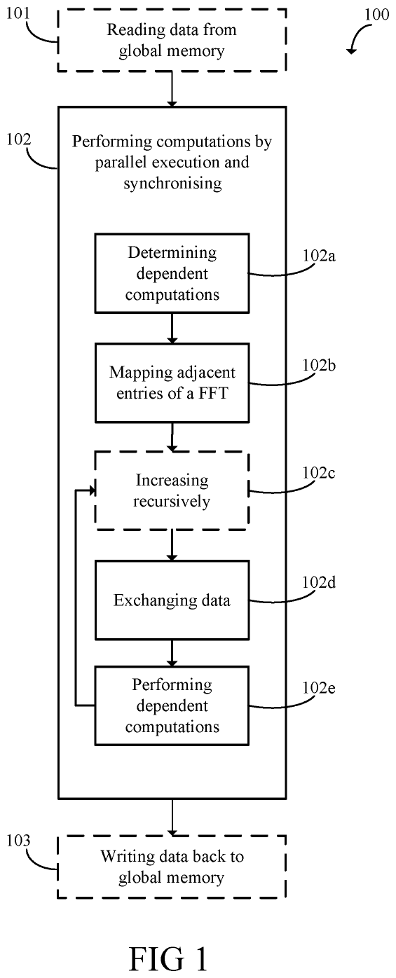

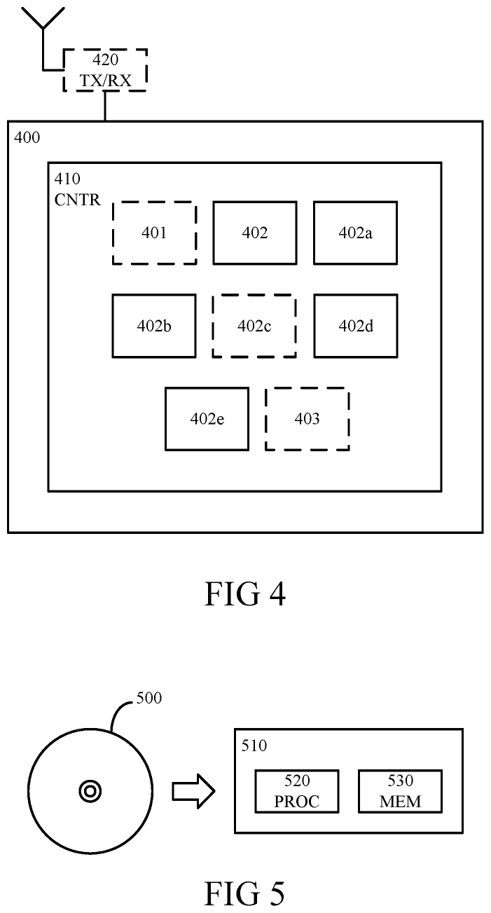

FIG. 1 is a flowchart illustrating method steps of an example method 100 according to some embodiments. The method 100 is for accelerating computations in a processor. Thus, the method 100 may, for example, be performed by the apparatus 400 and/or the controller 410 of FIG. 4; all of which will be described later herein.

The method 100 comprises the following steps.

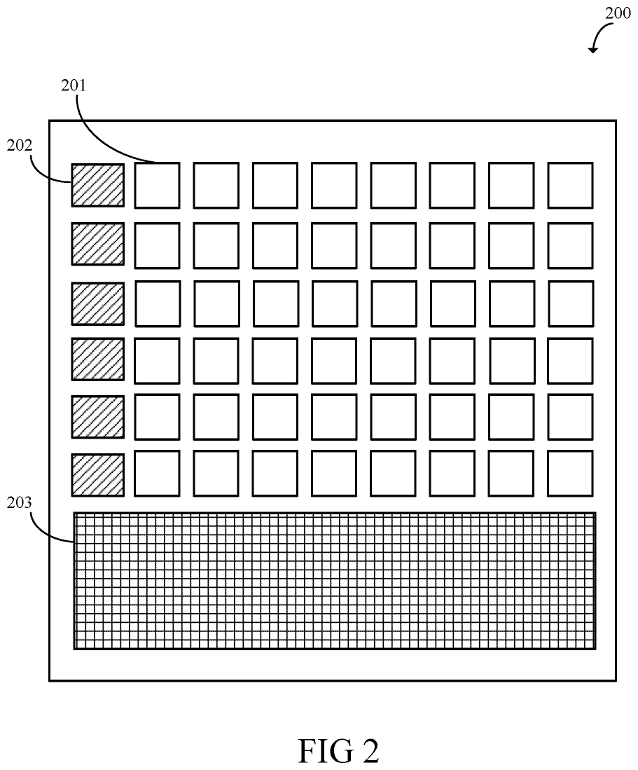

In optional step 101, in some embodiments, data is read from a global memory (reference to FIG. 2).

Alternatively or additionally, data may be read from cached memory.

In step 102, computations are performed by parallel execution of one or more threads in one or more processing elements by using a shared memory (reference to FIG. 2), wherein the one or more threads are synchronized by following steps 102a, 102b, 102d, 102e.

In step 102a, dependent computations of the one or more threads in a warp are determined, wherein the warp comprises a pre-determined number of threads.

For example, dependent computations may comprise computations wherein results of a previous step is used as input in computations in a current step.

In step 102b, adjacent entries of a fast Fourier transform (FFT) are mapped to respective threads of the determined dependent computations of the warp.

Alternatively or additionally, the mapping between the entries in the FFT are such that dependent calculations are performed in adjacent threads for a first N steps and only using local synchronization prior to the N:th step. Optionally, in some embodiments, dependent calculations are performed by using local memory, i.e. shared memory, within the warp.

In some embodiment, the number of calculations and values per thread are varied accordingly to the overhead induced by synchronization and possibly memory exchange in the hardware (reference to FIG. 2).

Hence, by adjusting the mapping of the entries in the FFT to a hardware comprising one or more processing units configured for performing computations by parallel execution of the one or more threads, faster calculation speed, less computational overhead and less memory utilization may be achieved.

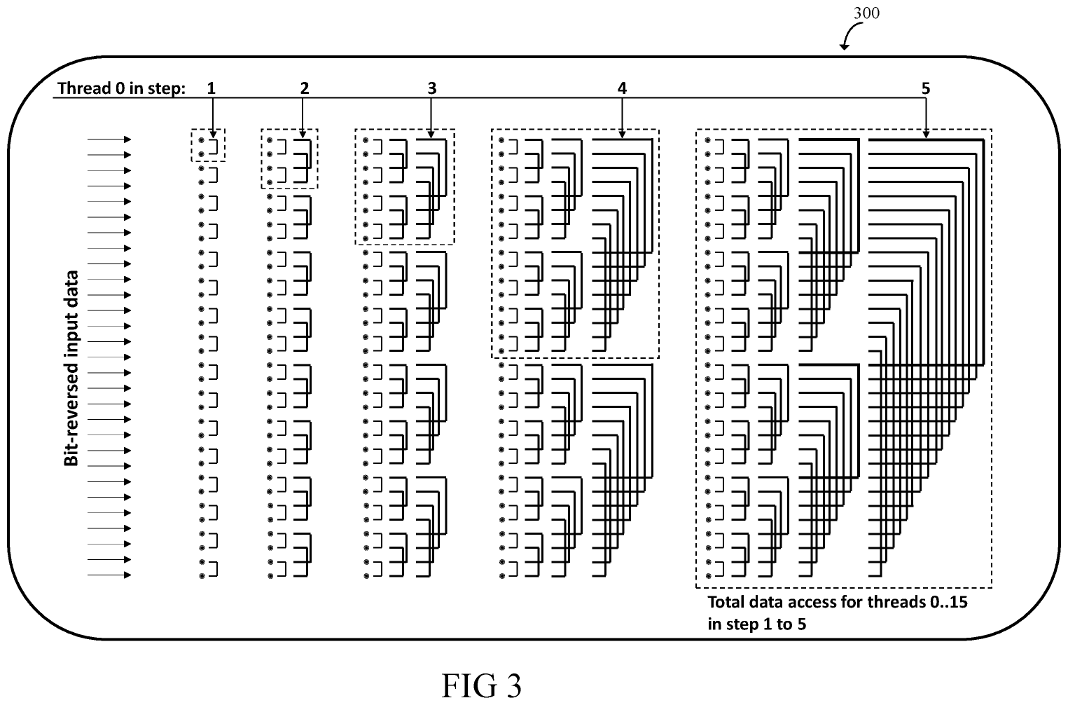

In optional step 102b -1, in some embodiments, symbols of FFT entry indices are reordered and an order of the FFT thread entries is arranged in accordance with the mapping (reference to FIG. 3).

In optional step 102c, in some embodiments, a set of adjacent FFT thread indices are recursively increased for each step in the FFT and corresponding data entry indices are calculated as intermediate results. (reference to FIG. 3).

In some embodiments, the exchanged data between the one or more respective threads comprises the intermediate results.

For example with reference to FIG. 3, firstly performing, e.g. size 2 FFTs, on all adjacent entries (reference to step 1 in FIG. 3) and then combing this data (reference to step 2 in FIG. 3) by performing new size 2 FFTs that forms size 4 FFTs. Hence, by increasing recursively the total FFT size becomes larger and larger.

For example, the one or more respective threads may use registers, i.e. shared memory, for computing FFTs.

In step 102d, data is exchanged between the one or more respective threads (reference to FIG. 3).

In some embodiments, the exchanging of data between the one or more respective threads comprises exchanging data directly between the one or more respective threads e.g. by using local memory and/or by using the shared memory.

For example with reference to FIG. 3, exchanging data between threads comprises that (in step 1 of FIG. 3) thread 0 changes data in dots 0 and 1; the data in dot 1 is read by thread 1 (in step 2 of FIG. 3) and exchange of data between thread 0 and 1 in dot 1, then, thread 0 performs computations using dot 0 and 2, thread 1 using dot 1 and 3.

In step 102e, the determined dependent computations of the respective threads are performed based on exchanged data between the one or more respective threads (reference to FIG. 3).

For example with reference to FIG. 3, performing dependent computations as the thread Os computations (in step 2 of FIG. 3) are dependent upon thread is computations (in step 1 of FIG. 3) and the same for thread 1 using dot 1.

In optional step 103, in some embodiments, data is written back to the global memory (reference to FIG. 2).

Any of the above steps for FIG. 1 may additionally have features identical with or corresponding to any of the various features as explained below for FIGS. 2-5.

FIG. 2 is a schematic block diagram illustrating an example hardware 200 according to some embodiments. The hardware 200 is for accelerating computations in a processor. Thus, the hardware 200 may, for example, be configured to perform one or more of the method steps of FIG. 1 and/or one or more data access steps of FIG. 3, and/or be comprised partially or completely by the apparatus 400 and/or the controller 410 of FIG. 4; all of which will be described later herein.

It should be noted that, even if embodiments are described herein in the context of accelerating computations in hardware of a processor, the hardware 200 may be comprised in the processor and/or in a cloud environment.

For example, a complete or partial implementation in a cloud environment is especially beneficial as the hardware 200 may serve multiple applications, e.g. any gain may be harvested by running other applications on freed resources.

FIG. 2 illustrates hardware 200 comprising one or more processing units 201 comprising one or more processing elements, wherein the one or more processing elements (not shown) are configured to execute sequences of programmed instructions in parallel.

The hardware 200 comprising the one or more processing units 201 is configured to minimize the processing time by utilizing the one or more processing elements for parallel execution.

FIG. 2 further illustrates the hardware 200 comprising shared memory 202 associated with the one or more processing units 201 and configured to enable computations and/or exchange of data between one or more threads executing on the hardware 200.

The one or more processing units 201 may comprise one or more processing elements, wherein the one or more processing elements comprise arithmetic functional units.

In some embodiments, the one or more processing elements are configured to create, manage, schedule, and execute one or more threads.

In some embodiments, the one or more processing elements comprise one or more cores.

The shared memory 202 of the hardware may comprise Static Random Access Memory (SRAM), e.g. registers.

FIG. 2 further illustrates the hardware 200 comprising global memory 203 associated with the one or more processing units 201 and configured to be read and written to according to a memory access pattern.

The global memory 203 of the hardware may comprise Dynamic Random Access Memory (DRAM), e.g. cache memory.

The hardware 200 may, in some embodiments, be comprised in a processor, wherein the processor comprises a Graphics Processing Unit (GPU).

The hardware 200 may, in some embodiments be comprised in a cloud environment, wherein the cloud environment comprises processing capabilities provided by parallel resources configured to enable computations and/or exchange of data between one or more threads executing on the hardware 200.

The hardware 200 may, in some embodiments, be comprised in both a processor and a cloud environment as a distributed hardware system.

Hence, by using hardware 200, e.g. general-purpose hardware with parallel processing elements, and FFT in general, multiple applications may be served, e.g. any gain may be harvested by running other applications on freed resources.

FIG. 3 is a schematic drawing illustrating an example data access pattern 300 according to some embodiments. The data access pattern 300 provides a pattern enabling accelerated computations in a processor. Thus, the data access pattern 300 may, for example, be performed by the hardware 200 of FIG. 2 and/or by the apparatus 400 and/or the controller 410 of FIG. 4; all of which will be described later herein.

In some embodiments, steps 102c, 102d, and 102e (looping) of FIG. 1 correspond to the steps from left to right in FIG. 3.

In FIG. 3, the dots are data and the line combing data dots are threads accessing the data.

In the first step of FIG. 3 (corresponding to step 102c of FIG. 1), an FFT can be described recursively by first performing e.g. a size 2 FFTs on all adjacent entries.

In the second step of FIG. 3 (corresponding to step 102d of FIG. 1), the data of the first step may be combined by doing new size 2 FFTs that form size 4 FFTs. As the dots are data, and the line combing data dots are threads accessing the data, the recursive increase comprises the larger and larger total FFT size. The exchange of data (between threads) is in the first step, wherein thread 0 changes data in dots 0 and 1; and the data in dot 1 is read by thread 1 in the second step (exchange of data between thread 0 and 1 in dot 1).

In the third step of FIG. 3 (corresponding to step 102e of FIG. 1), thread 0 performs computations using dot 0 and 2, thread 1 using dot 1 and 3 (as the thread Os computations in the second step are dependent upon thread is computations in the first step (and the same for thread 1 using dot 1).

FIG. 3 illustrates an embodiment based upon that for any sequence of primes, e.g. 2, 3 and 5, a FFT of size 2^{m}3ⁿ5^{k} may be constructed by first shuffling the input (bit-reversal for n=k=0), and then recursively increasing the total set of adjacent indices of data needed in the FFT to calculate intermediate results.

Considering, for example, that, in step 5 of FIG. 3, this calculation will use data from the bit-reversed indices 0 . . . 31 in the input data, this data is being calculated by thread 0 . . . 15 and hence in the 4th synchronization, these 16 threads will synchronize prior to the calculation in step 5 and all data needed in step 5 will be synchronized.

Note that most of the calculations and data are already synchronized by previous synchronizations. That is, in principal only the two threads preparing the input data need to synchronize.

For example, (with emphasis added in bold in FIG. 3) in step 5, thread 0 accesses data prepared by thread 0 and 16 in step 4. Hence, in principal only these two must synchronize in order for thread 0 to perform the calculation in step 5.

For a processor, e.g. a GPU, the warp size and hence, the synchronization granularity is 32=2⁵, which implies that the method steps of FIG. 1 and corresponding steps in the data access pattern of FIG. 3 work while the FFT is performing Radix-2 in the beginning, i.e. in step 1 of FIG. 3. Or generally only for steps such that the total FFT size about to be performed is a divider to the “warp size”, if it is not a divider global sync is needed unless the total FFT size is smaller than what can fit in one warp (depending on the values per thread).

How large a set of adjacent entries being handled by e.g. a single warp depends on the number of values and the number of calculations handled by each thread. For example, for radix-2 (n=k=0), if each thread handles 2 values e.g. performs a size 2 FFT, then 64 values falls within the same warp and hence the 5 first synchronizations can be _syncwarp, if each thread handles 4 values e.g. performs size 4 FFT, then the first 6 synchronizations can be _syncwarp.

Note that this implies that better parallelism is achieved in the computations of the FFT as one warp can start calculating step, e.g. step 6, while another warp is still performing calculations in step 5.

Hence, by utilizing local synchronization better parallelism is achieved in FFT calculations on hardware such as hardware 200 of FIG. 2.

FIG. 4 is a schematic block diagram illustrating an example apparatus 400 according to some embodiments. The apparatus 400 is for accelerating computations in a processor. Thus, the apparatus 400 and/or the controller 410 may, for example, be configured to perform one or more of the method steps of FIG. 1, and/or one or more of any steps otherwise described herein.

The apparatus 400 is for accelerating computations in a processor comprising one or more processing units, wherein one or more threads of execution are associated with one or more processing elements and with a shared memory of the one or more processing units for performing computations by parallel execution of the one or more threads.

The apparatus 400 comprises a controller 410, e.g. device controlling circuitry, configured to cause computations by parallel execution of the one or more threads in the one or more processing elements by using the shared memory.

The controller 410 is further configured to cause synchronization of the one or more threads by: determination of dependent computations of the one or more threads in a warp, wherein the warp comprises a pre-determined number of threads, mapping of adjacent entries of a fast Fourier transform, FFT, to respective threads of the determined dependent computations of the warp, exchange of data between the one or more respective threads, and performance of the determined dependent computations of the respective threads based on exchanged data between the one or more respective threads.

The apparatus 400 comprises, as mentioned above, the controller (CNTR; e.g., control circuitry or a controlling module) 410, which may in turn comprise, (or be otherwise associated with; e.g., connected or connectable to), a computer 402, e.g. computing circuitry or computing module, configured to perform computations by parallel execution of the one or more threads in the one or more processing elements by using the shared memory (compare with step 102 of FIG. 1).

The controller 410 further comprises, (or is otherwise associated with; e.g., connected or connectable to), a determiner 402a, e.g. determining circuitry or determining module, configured to determine dependent computations of the one or more threads in a warp, wherein the warp comprises a pre-determined number of threads (compare with step 102a of FIG. 1).

The controller 410 further comprises, (or is otherwise associated with; e.g., connected or connectable to), a mapper 402b, e.g. mapping circuitry or mapping module, configured to map adjacent entries of a fast Fourier transform, FFT, to respective threads of the determined dependent computations of the warp (compare with step 102b of FIG. 1).

The controller 410 further comprises, (or is otherwise associated with; e.g., connected or connectable to), a data exchanger 402d, e.g. data exchanging circuitry or data exchanging module, configured to exchange data between the one or more respective threads (compare with step 102d of FIG. 1).

The controller 410 further comprises, (or is otherwise associated with; e.g., connected or connectable to), a computations performer 402e, e.g. computations performing circuitry or computations performing module, configured to perform computations by parallel execution of the one or more threads in the one or more processing elements by using the shared memory (compare with step 102e of FIG. 1).

In some embodiments, the controller 410 further comprises, (or is otherwise associated with; e.g., connected or connectable to), an increaser 402c, e.g. increasing circuitry or increasing module, configured to recursively increase a set of adjacent FFT thread indices for each step in the FFT and calculating corresponding data entry indices as intermediate results (compare with step 102c of FIG. 1).

In some embodiments, the controller 410 further comprises, (or is otherwise associated with; e.g., connected or connectable to), a data reader 401, e.g. data reading circuitry or data reading module, configured to read data from global memory (compare with step 101 of FIG. 1).

In some embodiments, the controller 410 further comprises, (or is otherwise associated with; e.g., connected or connectable to), a data writer 403, e.g. data writing circuitry or data writing module, configured to write data back to global memory (compare with step 103 of FIG. 1).

In some embodiments, the apparatus is operably connectable to general-purpose hardware comprising processing elements configured to perform computations by parallel execution of the one or more threads.

In some embodiments, the general-purpose hardware comprising the processing elements is comprised in the processor and/or in a cloud environment.

In some embodiments, a processor comprises the apparatus as described in FIG. 4.

In some embodiments, the processor comprises a Graphics Processing Unit (GPU).

The apparatus 400 may further optionally comprise, (or be otherwise associated with; e.g., connected or connectable to), in some embodiments, a transceiver TX/RX 420, e.g. transceiving circuitry or transceiving module, configured to transmit and receive radio signals e.g. in accordance with accelerating computations in a processor.

Generally, when an apparatus is referred to herein, it is to be understood as a physical product. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), Graphics Processing Units (GPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device.

Embodiments may appear within an electronic apparatus (such as a wireless communication device) comprising arrangements, circuitry, and/or logic according to any of the embodiments described herein. Alternatively or additionally, an electronic apparatus (such as a wireless communication device) may be configured to perform methods according to any of the embodiments described herein.

According to some embodiments, a computer program product comprises a computer readable medium such as, for example a universal serial bus (USB) memory, a plug-in card, an embedded drive or a read only memory (ROM).

FIG. 5 illustrates an example computer readable medium in the form of a compact disc (CD) ROM 500. The computer readable medium has stored thereon a computer program comprising program instructions. The computer program is loadable into a data processor (PROC) 520, which may, for example, be comprised in a wireless communication device 510. When loaded into the data processor, the computer program may be stored in a memory (MEM) 530 associated with or comprised in the data processor.

In some embodiments, the computer program may, when loaded into and run by the data processing unit, cause execution of method steps according to, for example, FIG. 1 and/or one or more of any steps otherwise described herein.

In some embodiments, the computer program may, when loaded into and run by the data processing unit, cause execution of steps according to, for example, FIG. 1 and/or FIG. 3 and/or one or more of any steps otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for accelerating computations in a processor comprising one or more processing units, one or more threads of execution being associated with one or more processing elements and with a shared memory of the one or more processing units for performing computations by parallel execution of the one or more threads, the method comprising:
performing computations by parallel execution of the one or more threads in the one or more processing elements by using the shared memory, the one or more threads being synchronized by:
determining dependent computations of the one or more threads in a warp, the warp having a pre-determined number of threads;
mapping adjacent entries of a fast Fourier transform, FFT, to respective threads of the determined dependent computations of the warp;
exchanging data between the one or more respective threads; and
performing the determined dependent computations of the respective threads based on exchanged data between the one or more respective threads.

2. The method according to claim 1, further comprising:
increasing recursively a set of adjacent FFT thread indices for each step in the FFT and calculating corresponding data entry indices as intermediate results.

3. The method according to claim 2, wherein the exchanged data between the one or more respective threads comprises the intermediate results.

4. The method according to claim 1, wherein the exchanging of data between the one or more respective threads comprises one or more of:
exchanging data directly between the one or more respective threads; and
using the shared memory.

5. The method according to claim 1, wherein the mapping of the entries in the FFT comprises reordering symbols of FFT entry indices and arranging an order of the FFT thread entries in accordance with the mapping.

6. The method according to claim 1, wherein the one or more processing units are associated to a global memory.

7. The method according to claim 6, further comprising:
reading data from the global memory; and
writing data back to the global memory.

8. The method according to claim 5, wherein the reordering comprises shuffling symbols of the FFT entry indices to bit-reverse the order of the FFT thread entries for a Radix-2 FFT.

9. The method according to claim 6, wherein the global memory comprises Dynamic Random Access Memory, DRAM.

10. The method according to claim 1, wherein the shared memory comprises Static Random Access Memory, SRAM.

11. The method according to claim 1, wherein the processor comprises a Graphics Processing Unit, GPU.

12. The method according to claim 1, wherein the one or more processing elements comprise arithmetic functional units.

13. The method according to claim 1, wherein the one or more processing elements are configured to create, manage, schedule, and execute one or more threads.

14. The method according to claim 1, wherein the one or more processing elements comprise one or more cores.

15. A computer program product comprising a non-transitory computer readable medium, having thereon a computer program comprising program instructions, the computer program being loadable into a data processing unit and configured to cause execution of a method when the computer program is run by the data processing unit, the method being for accelerating computations in a processor comprising one or more processing units, one or more threads of execution being associated with one or more processing elements and with a shared memory of the one or more processing units for performing computations by parallel execution of the one or more threads, the method comprising:
performing computations by parallel execution of the one or more threads in the one or more processing elements by using the shared memory, the one or more threads being synchronized by:
determining dependent computations of the one or more threads in a warp, the warp having a pre-determined number of threads;
mapping adjacent entries of a fast Fourier transform, FFT, to respective threads of the determined dependent computations of the warp;
exchanging data between the one or more respective threads; and
performing the determined dependent computations of the respective threads based on exchanged data between the one or more respective threads.

16. An apparatus for accelerating computations in a processor comprising one or more processing units, one or more threads of execution being associated with one or more processing elements and with a shared memory of the one or more processing units for performing computations by parallel execution of the one or more threads, the apparatus comprising a controller configured to cause:
computations by parallel execution of the one or more threads in the one or more processing elements by using the shared memory, the one or more threads being synchronized by:
determination of dependent computations of the one or more threads in a warp, the warp comprising a pre-determined number of threads;
mapping of adjacent entries of a fast Fourier transform, FFT, to respective threads of the determined dependent computations of the warp;
exchange of data between the one or more respective threads; and
performance of the determined dependent computations of the respective threads based on exchanged data between the one or more respective threads.

17. The apparatus according to claim 16, wherein the apparatus is operably connectable to general-purpose hardware comprising processing elements configured to perform computations by parallel execution of the one or more threads.

18. The apparatus according to claim 16, wherein the general-purpose hardware comprising the processing elements is comprised in one or more of:
the processor; and
a cloud environment.

19. (canceled)

20. (canceled)

21. The method according to claim 2, wherein the mapping of the entries in the FFT comprises reordering symbols of FFT entry indices and arranging an order of the FFT thread entries in accordance with the mapping.

22. The method according to claim 3, wherein the mapping of the entries in the FFT comprises reordering symbols of FFT entry indices and arranging an order of the FFT thread entries in accordance with the mapping.
